(19) United States
(12) Patent Application Publication
(10) Pub. No.: US 2015/0100922 A1
(43) Pub. Date: Apr. 9, 2015

(54) METHOD AND SYSTEM FOR DISPLAYING USER-SPECIFIC INFORMATION ON-SCREEN CONTEMPORANEOUSLY WITH AN ANIMATED WIDGET

(71) Applicant: Kobo Incorporated, Toronto (CA)

(72) Inventor: Mark LEFEBVRE, Toronto (CA)

(73) Assignee: Kobo Incorporated, Toronto (CA)

(21) Appl. No.: 14/046,789

(22) Filed: Oct. 4, 2013

(51) Int. Cl. G06F 3/0482

(52) U.S. Cl. CPC G06F 3/0482
USPC 715/810

(57) ABSTRACT

Embodiments of the present invention are operable to display entertaining or amusing, user-specific content (e.g., amusing, short on-screen messages relating to the user's profession) adjacent to objects rendered during unresponsive system states (e.g., animated objects, such as a rotating wheel or hour glass animation, etc.). Additionally, content rendered by embodiments of the present invention may be related or unrelated to an application and/or a process currently being executed by computer system that may be causing the system's current unresponsive state. As such, embodiments of the present invention can improve an end-user's experience during unresponsive system states by entertaining end-users until the computer system can return to a previous activate state and resume performance of standard operations.

### FIELD OF THE INVENTION

Embodiments of the present invention are generally related to the field of graphics processing.

### BACKGROUND OF THE INVENTION

During standard operations, conventional computer systems (e.g., personal computers, mobile devices, etc.) may occasionally encounter unresponsive states in which a system may be unable to process any new requests and/or perform any new processes due to delays in executing a current process. As such, these systems are typically configured to render an animated object to the user's graphical user interface, such as a small rotating wheel, that provides implicit notification to the user that the computer system is currently operating within an unresponsive state. In this manner, users may become frustrated viewing the same object being displayed for the duration of system's unresponsive state while waiting for the computer system to return to a previous active state where it may resume performing standard operations.

### SUMMARY OF THE INVENTION

Accordingly, a need exists to improve the user's experience while waiting for the computer system to return to an active state. Embodiments of the present invention are operable to display entertaining or amusing, user-specific content (e.g., amusing, short on-screen messages relating to the user's profession) adjacent to objects rendered during unresponsive system states (e.g., animated objects, such as a rotating wheel or hour glass animation, etc.). Additionally, content rendered by embodiments of the present invention may be related or unrelated to an application and/or a process currently being executed by computer system that may be causing the system's current unresponsive state. As such, embodiments of the present invention can improve an end-user's experience during unresponsive system states by entertaining end-users until the computer system can return to a previous activate state and resume performance of standard operations.

More specifically, in one embodiment, the present invention is implemented as a method of rendering content on a computing device during an unresponsive state. The method includes rendering an animated object within a graphical user interface responsive to a detection of an unresponsive state associated with the computing device. The method also includes selecting an amusing content to be displayed contemporaneously with the animated object in which amusing content is user related and may be separate from an application or a system process executed by the computing device during the unresponsive state.

In one embodiment, the selecting further includes gathering user-specific data associated with a user, in which the amusing content includes user-specific data related to the user. In one embodiment, the user-specific data is related to a profession associated with the user. In one embodiment, the amusing content is a short message selected from a listing of short messages and displayed adjacent to the animated object. In one embodiment, the selecting further includes receiving a plurality of prospective content from a plurality of users and selecting the amusing content from the plurality of prospective content based on votes received from a plurality of voters.

In one embodiment, the receiving further comprises screening the plurality of prospective content for profanity. In one embodiment, the amusing content includes a plurality of short messages displayed during the unresponsive state. Additionally, the method includes rendering the amusing content contemporaneously with the animated object on the graphical user interface. Furthermore, the method includes detecting an active state associated with the computing device, in which rendering of the amusing content is terminated upon the detection of the active state.

In one embodiment, the present invention is implemented as a system for rendering content on a computing device during an unresponsive state. The system includes a rendering module operable to render an animated object to a graphical user interface displayed by the computing device responsive to a detection of an unresponsive state associated with the computing device, in which the rendering module is operable to render an amusing content contemporaneously with the animated object on the graphical user interface.

The system also includes a selection module operable to select the amusing content to be displayed contemporaneously with the animated object in which the amusing content may be separate from and unrelated to an application or a system process executed by the computing device during the unresponsive state. In one embodiment, the selection module is further operable to gather user-specific data associated with a user, in which the amusing content comprises user-specific data provided by the user. In one embodiment, the user-specific data is related to a profession associated with the user. In one embodiment, the amusing content is a short message displayed adjacent to the animated object.

In one embodiment, the selection module is further operable to receive a plurality of prospective content from a plurality of users and select the amusing content from the plurality of prospective content based on votes received from a plurality of voters. In one embodiment, the amusing content comprises a plurality of short messages displayed during the unresponsive state. Furthermore, the system includes a detection module operable to detect an active state associated with the computing device, in which the rendering module is operable to terminate rendering of the amusing content is upon the detection of the active state by the detection module. In one embodiment, the system includes a screening module operable to screen the plurality of prospective content for profanity.

In one embodiment, the present invention is implemented as a method of rendering content on a client device during an unresponsive state. The method includes, using a host device, rendering an animated object on a graphical user interface associated with a client device responsive to a detection of an unresponsive state associated with the host device. Also, the method includes selecting an amusing content to be displayed contemporaneously with the animated object on the client device in which the amusing content is user specific and may be separate from an application or a system process executed by the host device during the unresponsive state. In one embodiment, the selecting further includes gathering user-specific data associated with a user, in which the amusing content comprises user-specific data that may be in part provided by a user using a client device.

In one embodiment, the user-specific data is related to a profession associated with the user. In one embodiment, the amusing content is a short message selected from a list of short messages and displayed adjacent to the animated object. In one embodiment, selecting further includes receiving a plurality of prospective content from a plurality of users and selecting the amusing content from the plurality of prospective content based on votes received from a plurality of voters. In one embodiment, the amusing content is an advertisement. In one embodiment, the amusing content comprises a plurality of short messages displayed during the unresponsive state.

Additionally, the method includes rendering the amusing content contemporaneously with the animated object on the graphical user interface. Furthermore, the method includes detecting an active state associated with the host device, in which rendering of the amusing content is terminated upon the detection of the active state.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an exemplary computing system environment for displaying amusing, user-specific content during an unresponsive state in accordance with embodiments of the present invention.

FIG. 2A depicts an exemplary network communication between an exemplary computing system environment and a plurality of remote client devices in accordance with embodiments of the present invention.

FIG. 2B depicts an exemplary mobile device for displaying amusing, user-specific content during an unresponsive state in accordance with embodiments of the present invention.

FIG. 2C depicts an exemplary content storing data structure capable of storing user-specific content in accordance with embodiments of the present invention.

FIG. 2D depicts exemplary display periods associated with a set of user-specific content displayed during an extended wait period in accordance with embodiments of the present invention.

FIG. 2E depicts an exemplary set of user-specific content displayed during an extended wait period in accordance with embodiments of the present invention.

FIG. 3A depicts an exemplary method of selecting content for display to end-users in accordance with embodiments of the present invention.

FIG. 3B depicts an exemplary display prompt that may be used to gather user feedback concerning prospective content in accordance with embodiments of the present invention.

FIG. 3C depicts an exemplary feedback gathered from a plurality of voters concerning prospective content in accordance with embodiments of the present invention.

FIG. 4A shows a flowchart of an exemplary computer controlled process for displaying user-specific content on-screen contemporaneously with an animated widget in accordance with embodiments of the present invention.

FIG. 4B shows a flowchart of an exemplary computer controlled process for selecting specific content for end-users using a voting process to determine specific content for end-users in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

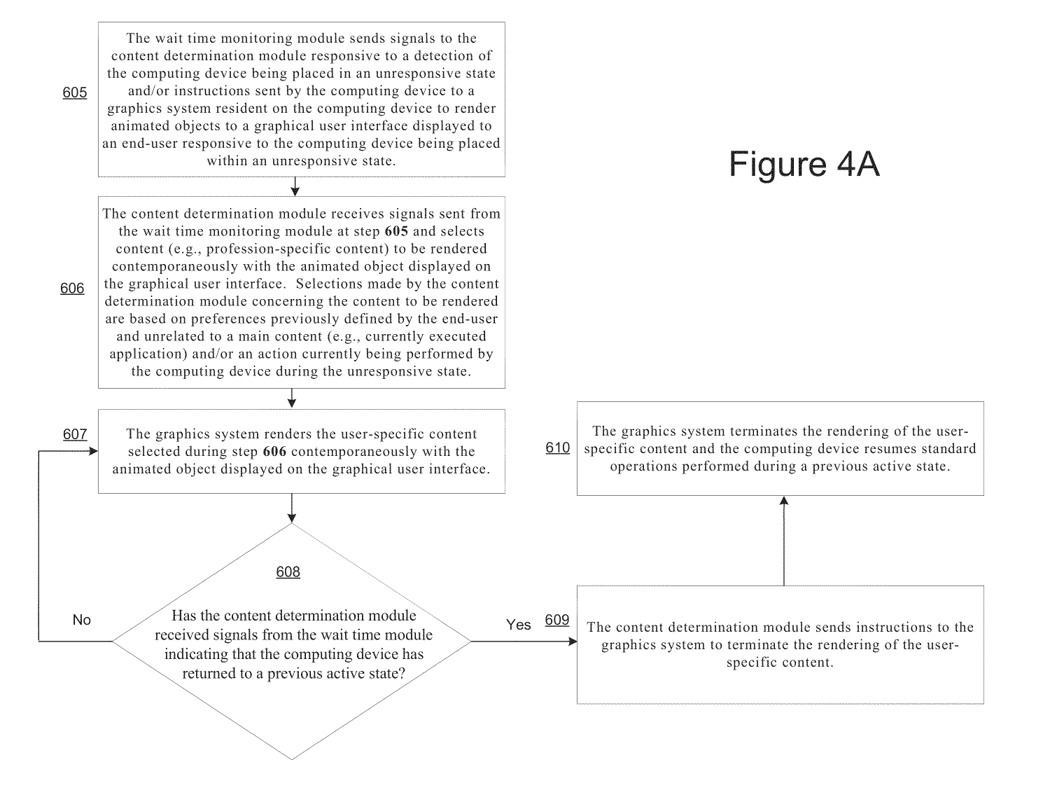

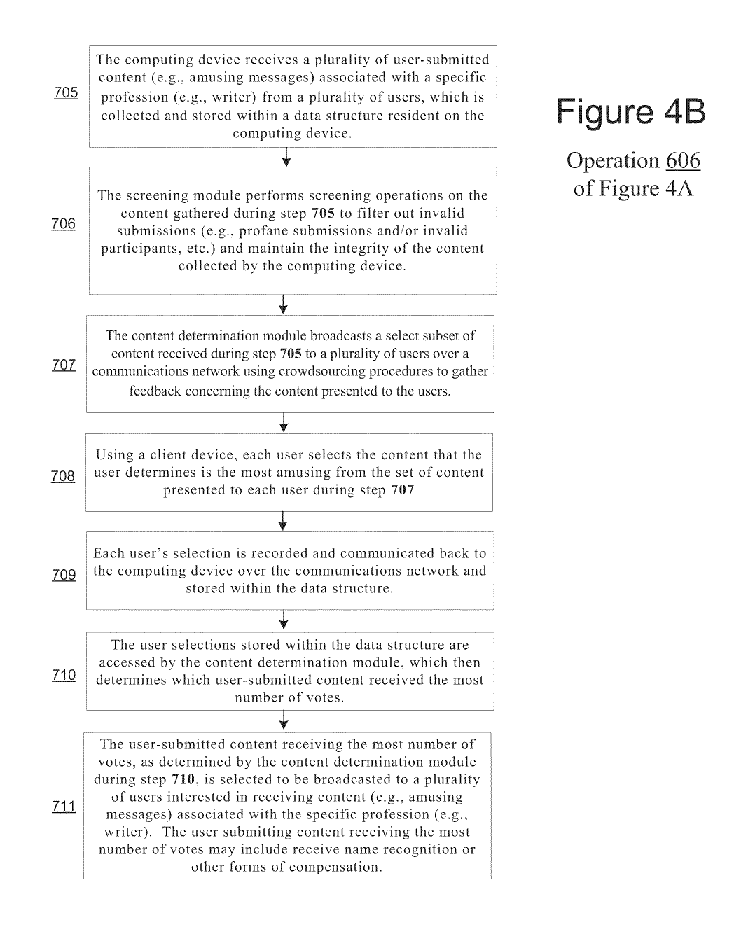

Portions of the detailed description that follow are presented and discussed in terms of a process. Although operations and sequencing thereof are disclosed in a figure herein (e.g., FIGS. 4A, 4B, etc.) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, a subject, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary System for Displaying User-Specific Information on-Screen Contemporaneously with an Animated Widget

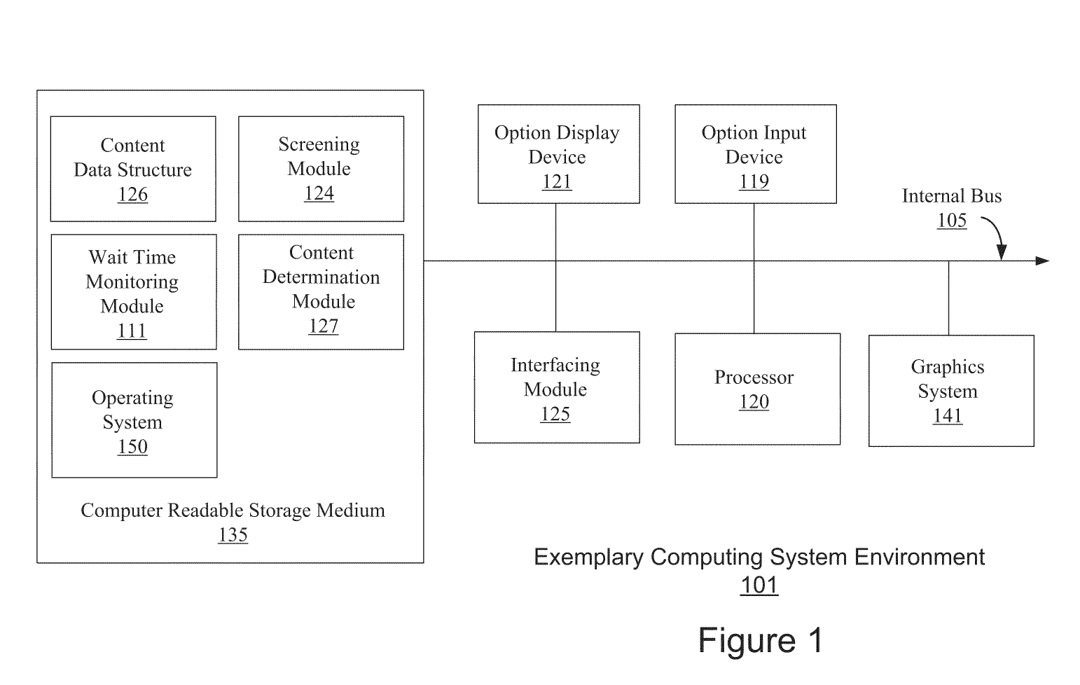

FIG. 1 illustrates exemplary components used by various embodiments of the present invention. Although specific components are disclosed in computing system environment 100, it should be appreciated that such components are exemplary. That is, embodiments of the present invention are well suited to having various other components or variations of the components recited in computing system environment 100. It is appreciated that the components in computing system environment 100 may operate with other components than those presented, and that not all of the components of system 100 may be required to achieve the goals of computing system environment 100.

FIG. 1 shows a block diagram of an exemplary computing system environment (e.g., computing system environment 100) and corresponding modules, in accordance with one embodiment of the present invention. Computing system environment 100 may include, but is not limited to, servers, desktop computers, laptops, tablet PCs, tablet computing devices, mobile devices, and smartphones. In its most basic configuration, computing system environment 100 typically includes at least one processing unit (e.g., processor 120) and computer readable storage medium 135. Depending on the exact configuration and type of computing system environment, computer readable storage medium 135 may be volatile (such as RAM), non-volatile (such as ROM, flash memory, etc.) or some combination of the two. Portions of computer readable storage medium 135 when executed facilitate efficient execution of memory operations or requests for groups of threads.

Additionally, computing system environment 100 may also have additional features/functionality. For example, computing system environment 100 may also include additional storage (removable and/or non-removable) including, but not limited to, magnetic or optical disks or tape. Additional storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

In one embodiment, computer readable storage medium 135 includes wait time monitoring module 111, content determination module 127, content data structure 126, screening module 124 and operating system 150.

Wait time monitoring module 111 may include the functionality to recognize states in which computing system environment 100 and/or an application executed on computing system 100 may be unresponsive to incoming requests or instructions due to delays in executing a process or a set of processes. Factors that may result in delays may include, for example, increases in the amount of time various components within computing system environment 100 (e.g., processor 120) take to execute various instructions (e.g., read/write instructions, etc.).

In one embodiment, wait time monitoring module 111 may be configured to recognize delays of up to a pre-determined time period threshold (e.g., minimum of 1 second) and may correspondingly send signals to content determination module 127 responsive to a detection of delays meeting the pre-determined threshold or other means of detecting computing system environment 100 being placed in an unresponsive state. In one embodiment, wait time monitoring module 111 may be configured to send signals responsive to computing system environment 100 returning to a previous active state (e.g., state in which computing system environment 100 or an application executed on computing system environment 100 may be able to respond to new requests or instructions).

In one embodiment, wait time monitoring module 111 may include the functionality to send signals to content determination module 127 responsive to a detection of events that include objects (e.g., animated objects) being rendered to a graphical user interface displayed before an end-user responsive to computing system environment 100 being placed in an unresponsive state. In one embodiment, animated objects may include any animation that represents a passage of time (e.g., “rotating wheel” widgets, “hour-glass” widgets, “rotating arrow” widgets, “writing pencil” widgets or other animation widgets, etc.).

In one embodiment, wait time monitoring module 111 may also include the functionality to send signals to content determination module 127 responsive to computing system environment 100 being returned to a previous active state and/or a detection of animated objects no longer being rendered to a graphical user interface in response to computing system environment 100 being returned to a previous active state.

In one embodiment, wait time monitoring module 111 may include the functionality to detect unresponsive states and/or instructions to render animated objects based on data gathered from operating system 150. In one embodiment, wait time monitoring module 111 may include the functionality to detect unresponsive states and/or instructions to render animated objects during unresponsive states based on data gathered from a remote client device (e.g., data gathered from web browsing application executed on the client device).

Content determination module 127 may include the functionality to receive signals from wait time monitoring module 111 and correspondingly send instructions to components within computing system environment 100 (e.g., graphics system 141) to render content (e.g., short messages, short advertisements, images, or other content capable of being viewed within a short time period, etc.) that is applicable to a user (“user-specific”) and may be intentionally unrelated to a currently executed application and/or an action currently being performed by computing system environment 100 that may be causing the unresponsive state. For instance, in one embodiment, content determination module 127 may instruct graphics system 141 to render content applicable to a user's profession or other user-related or specific-character trait or other trait.

In one embodiment, content determination module 127 may include the functionality to instruct graphic system 141 to render user-specific content contemporaneous to the rendering of animated objects displayed on a graphical user interface during unresponsive system or application states. In one embodiment, content determination module 127 may include metadata within instructions sent that includes coordinate data for positioning the user-specific content relative to the rendered animated object. In one embodiment, content determination module 127 may include the functionality to render a plurality of user-specific content during detected unresponsive states.

In one embodiment, content determination module 127 may include the functionality to send instructions to terminate the rendering of the user-specific content responsive to signals received from wait time monitoring module 111 indicating that computing system environment 100 has returned to a previous active state.

Also, in one embodiment, content determination module 127 may include the functionality to assign a plurality of different content to one or many different end-users based on preferences previously defined by the user (e.g., preferences stored within content data structure 126). In one embodiment, content determination module 127 may be configured to classify or categorize user-specific content using pre-determined sorting criteria and/or learning machine procedures.

In one embodiment, content determination module 127 may include the functionality to analyze feedback received from end-users over a communications network concerning prospective content for incorporation in a listing for selection and display during future unresponsive states. In one embodiment, content determination module 127 may include the functionality to use crowdsourcing procedures to gather content and/or feedback directly from end-users for selection of prospective content.

Content data structure 126 (e.g., database) may include the functionality to store a plurality of different content for a plurality of different end-users. In one embodiment, content data structure 126 may include the functionality to use storing tables or lists that may accessible to components within computing system environment 100 (e.g., content determination module 127). In one embodiment, content data structure 126 may include the functionality to store data gathered via graphical user interfaces (GUIs).

Screening module 124 may include the functionality to perform various screenings or filters on the content received from end-users. In one embodiment, screening module 124 may include the functionality to perform screening procedures prior to content determination module 127 analyzing content received from end-users.

Graphics system 141 may include the functionality to receive instructions and/or signals from various components within computing system environment 100 (e.g., content determination module 127) and correspondingly generate a stream of data (e.g., user-specific content determined by content determination module 127) that may be rendered to a display device of computing system environment 100 (e.g., optional display device 121).

In one embodiment, graphics system 141 may receive instructions and/or signals from content determination module 127 and correspondingly generate a stream of data (e.g., user-specific content determined by content determination module 127) that may rendered to a display device on a remote client device over a communications network. In one embodiment, resultant data generated by graphics system 141 may be included as metadata communicated from computing system environment 100 to remote client devices. In one embodiment, graphics system 141 may include a plurality of graphics processors, frame memory buffers, and other graphics system components that may assist in the rendering process.

Interfacing module 120 may include the functionality to allow computing system environment 100 to communicate with other devices. In one embodiment, interfacing module 120 may enable computing system environment 100 to receive communication media. Communication media typically embodies computer readable instructions, data structures, program modules or other data in a modulated data signal such as a carrier wave or other transport mechanism and includes any information delivery media. The term computer readable media as used herein includes both storage media and communication media.

Interfacing module 120 may include the functionality to allow computing system environment 100 to communicate over various networks types including, but not limited to, fiber channel, small computer system interface (SCSI), Bluetooth, Ethernet, Wi-Fi, Infrared Data Association (IrDA), Local area networks (LAN), Wireless Local area networks (WLAN), Near Field Communication (NFC), Code Division Multiple Access (CDMA), Global System for Mobile Communications (GSM), Long-term Evolution (LTE), Worldwide Interoperability for Microwave Access (WiMax), wide area networks (WAN) such as the internet, serial, and universal serial bus (USB). It is appreciated the various network types that interfacing module 120 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 100 may also include optional display device 121 which may include the functionality to render output. Examples of optional display device 121 may include, but are not limited to, a liquid crystal display (LCD), a plasma display, cathode ray tube (CRT) monitor, etc. Computing system environment 100 may also include optional input device(s) 121 such as a touch screen (e.g., capacitive touch screen), keyboard, mouse, pen, voice input device, touch input device, remote control, camera, etc. Computing system environment 100 may further include a power source (e.g., battery) (not shown) operable to allow computing system environment 100 to be movable and mobile while operating.

### Exemplary Method for Displaying User-Specific Information on-Screen Contemporaneously with an Animated Widget

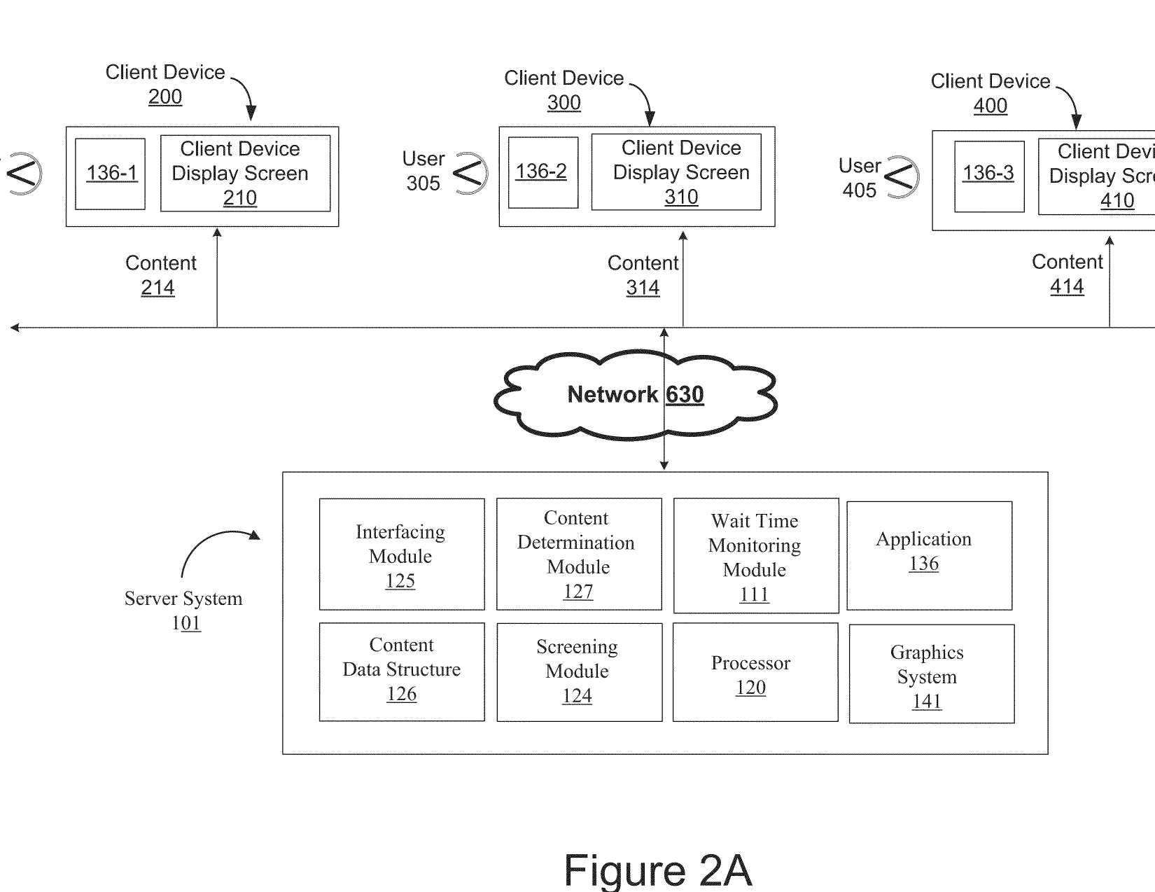

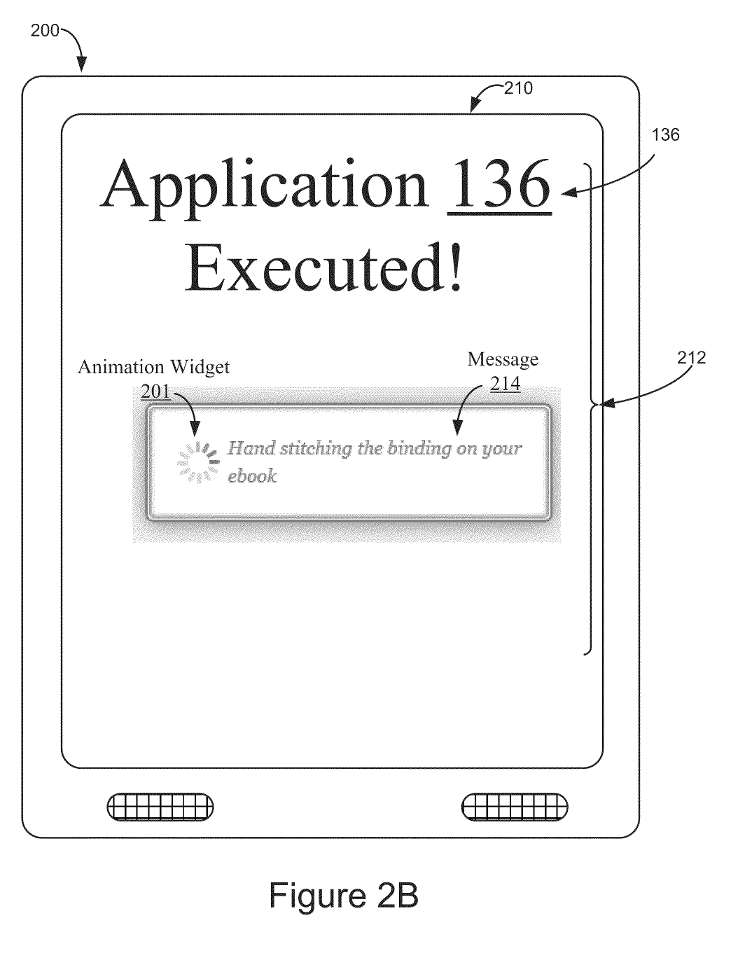

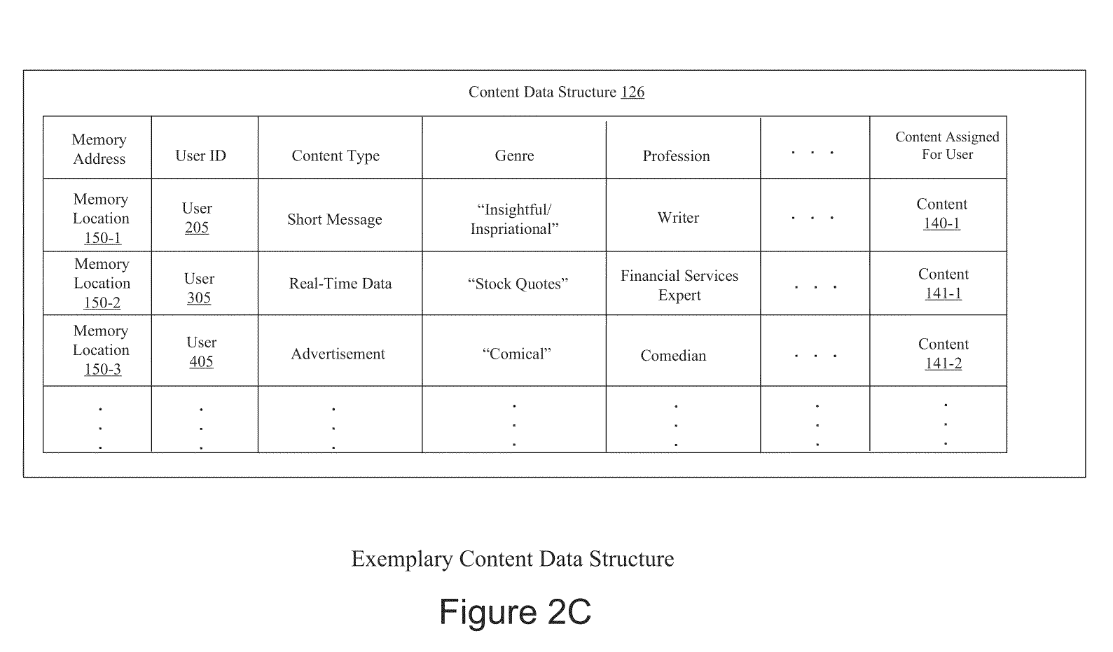

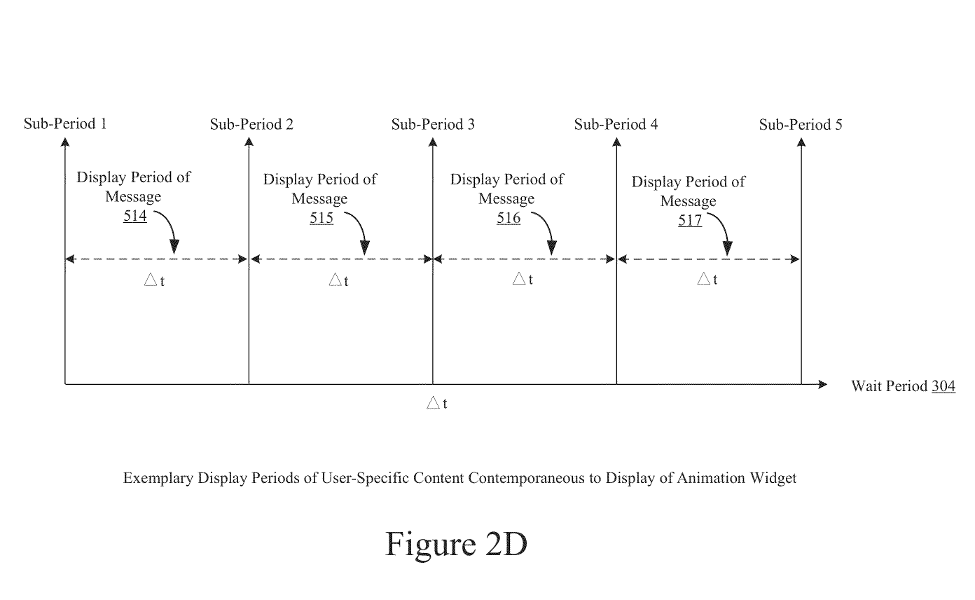

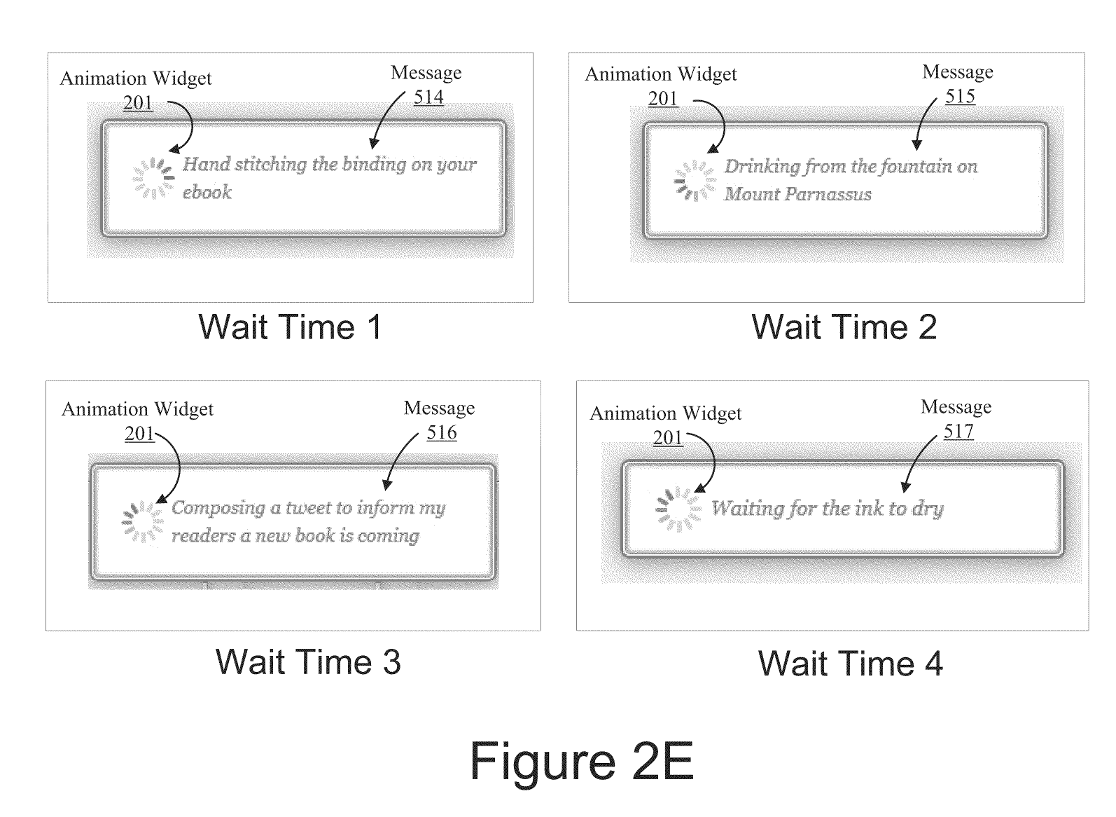

FIG. 2A provides an exemplary network communication between an exemplary computing system environment (e.g., server system 101) and a plurality of remote client devices (e.g., client devices 200, 300, 400, etc.) in accordance with embodiments of the present invention. In one embodiment, server system 101 may be implemented as a server, laptop, desktop computer or the like, as contemplated by embodiments of the present invention. Also, in one embodiment, server system 101 may be implemented as a data center, remote server, or virtualized server.

Additionally, embodiments of the present invention support server system 101 being implemented as a remote virtual host server that is communicably coupled to a plurality of remote client devices over a communications network (e.g., network 630) and operable to execute multiple instantiations of an application. In one embodiment, server system 101 may be operable to respond one or more requests made by a plurality of remote client devices (e.g., client devices 200, 300, 400, etc.) over a communications network. Network 630 may be a wireless network, a wired network, or a combination thereof.

In one embodiment, application 136 may be an application executed by a plurality of client devices (e.g., application 136-1, 136-2, 136-3, etc.) that contains a set of instructions for accessing content stored on server system 101 over a communications network (e.g., network 630). As such, in one embodiment, application 136 may be a hosted application (e.g., application hosted by server system 101) configured to access data (e.g., real-time information) stored on server system 101 responsive to a client device request (e.g., requests from client devices 200, 300, 400, etc.) and communicate the requested data back to the requesting client device via interfacing module 125.

Occasionally, server system 101 may be placed within an unresponsive state when executing a process or a set of processes (e.g., processes for application 136) responsive to user input, for example. As such, server system 101 may be unable to respond to new requests from remote client devices and/or perform new system processes. As such, server system 101 may be configured to instruct the graphical user interfaces of client devices in communication with server system 101 to render an object (e.g., animated objects) for display to end-users on their respective display devices (e.g., client device display screens 210, 310, 410, etc.) until server system 101 completes execution of the process causing the unresponsive state. In this manner, the rendered objects may provide implicit and/or explicit notification to the user that server system 101 is currently engaged within an unresponsive state. Unresponsive states may be of varying lengths and thus, end-users may experience prolonged wait times of unknown durations. In one embodiment, data associated with rendered objects may be generated via graphics system 141.

According to one embodiment, wait time monitoring module 111 may be capable of detecting unresponsive states associated with server system 101 and may correspondingly send signals to content determination module 127. As such, in one embodiment, responsive to the signals received from wait time monitoring module 111, content determination module 127 may perform operations which may enable server system 101 to communicate amusing, user-specific content for display to end-users on their respective display devices contemporaneous to the display of animated objects. In this manner, the end-user's experience may be improved as the user may be amused or entertained until server system 101 can return to a previous activate state (e.g., ready to respond to new requests and/or new processes). In one embodiment, the user-specific content may include amusing short messages or images unrelated to application 136 and/or the process currently being executed by server system 101 that is causing the unresponsive state.

According to one embodiment, content assigned to end-users may be determined by content determination module 127. In one embodiment, content determination module 127 may be configured to assign a plurality of different content to one or many different end-users (e.g., users 205, 305, 405, etc.) based on preferences stated by the end-users. In one embodiment, individual preferences may be stored within a data structure resident on server system 101 (e.g., content data structure 126). In this manner, content determination module 127 may be operable to communicate specific content to end-users based on data gathered and stored within content data structure 126.

In one embodiment, content determination module 127 may gather individual end-user preferences via display prompts presented to end-users requesting them to state their preferences towards a particular form of content (e.g., “comical” content, “insightful” content, “advice/tips” content, etc.). In one embodiment, content determination module 127 may be configured to determine user-specific content based on the end-user's stated profession. For example, an end-user may specify that she is a writer when prompted to state her profession. Accordingly, content determination module 127 may assign amusing content related to writers (e.g., amusing messages that relates to writers). Content classifications may be logically or arbitrarily determined by content determination module 127. In one embodiment, content determination module 127 may be configured to classify content using pre-determined sorting criteria and/or learning machine procedures.

With further reference to the embodiment depicted in FIG. 2A, during an unresponsive state associated with server system 101, client devices 200, 300 and 400 may be configured to render an animated object (e.g., small rotating wheel) for the duration of the wait time experienced by each end-user (e.g., users 205, 305, 405) while server system 101 completes the process causing the unresponsive state.

Additionally, as illustrated in FIG. 2A, contemporaneous to the display of the rendered animated object during the unresponsive state, server system 101 may also communicate different types of content for display to each respective end-user based on their stated preferences. For instance, user 205 may define herself as a “writer” and may prefer receiving amusing content in the form of short messages. Also, user 305 may define herself as a “financial services expert” and may prefer receiving content concerning financial topics in the form of real-time data. Furthermore, user 405 may define herself as being involved in the “advertisement” industry and may prefer receiving amusing content in the form of short advertisement messages or images.

As such, simultaneous to the rendering of the animated object on client device 200, server system 101 may also communicate (e.g., via interfacing module 125) message 214 to client device 200, which may be include amusing content related to writers in the form of a short message. In this manner, client device display screen 210 may render the content in message 214 for user 205 to view for the duration of the wait time experienced by user 205.

Also, simultaneous to the rendering of the animated object on client device 300, server system 101 may also communicate message 314 to client device 300, which may include real-time data pulled from an RSS feed that relates to the financial services industry (e.g., live stock quotes, news, etc.). As such, client device display screen 310 may render the content included in message 314 for user 305 to view for the duration of the wait time experienced by user 305.

Furthermore, simultaneous to the rendering of the animated object on client device 400, server system 101 may also communicate message 414 to client device 400, which may include amusing content related to the advertisement industry in the form of short advertisement messages or images. As such, client device display screen 410 may render the content included in message 414 for user 405 to view for the duration of the wait time experienced by user 405.

FIG. 2B depicts an exemplary mobile device temporarily displaying amusing, user-specific content during an unresponsive state in accordance with one embodiment of the present invention. Client device 200 (e.g., client device 200 of FIG. 1A) may be implemented as any mobile computing device (e.g., desktop computers, laptops, tablet PCs, tablet computing devices, mobile devices, and smartphones, or the like). As illustrated in FIG. 2B, graphical user interface 212 may render display data associated with an executed instantiation of application 136 (e.g., application hosted by server system 101).

As illustrated in FIG. 2B, there may be occasions in which server system experiences unresponsive states. As such, client device 200 may experience a wait time of unknown duration while server system 101 performs the process or set of processes causing the unresponsive state. In this manner, server system 101 may communicate instructions to graphical user interface 212 to display an animation widget 201 for the duration of the wait time. In one embodiment, animation widget 201 may be a small rotating wheel, an hourglass containing sand dribbling into a lower portion thereof, or other animation that indicates that a running process has yet to be completed by server system 101.

Simultaneous to the rendering of animation widget 201, according to one embodiment, server system 101 may also communicate instructions to graphical user interface 212 to render a short on-screen message (e.g., message 214) adjacent to animated widget 201. Accordingly, through message 214, server system 100 may be capable of delivering amusing, user-specific content during the wait period that is independent of a main content (e.g., application 136) and also independent of the process being performed by server system 101 that is causing the unresponsive state. As illustrated in FIG. 2B, in one embodiment, animation widget 201 and message 214 may appear in a pop-up window displayed to the end-user by server system 101. In one embodiment, animation widget 201 and message 214 may appear on a page (e.g., webpage) displayed by server system 101.

As illustrated by the embodiment depicted in FIG. 2B, message 214 may include content that may be relevant to the user's profession (e.g., writer) or other known user trait or user character and also makes light of the fact that the end-user (e.g. user 205) is currently waiting for server system 101 to return to an active state. As such, the content provided by server system 101 may be entertaining or amusing messages that may be intentionally unrelated to an action contemporaneously being performed by server system 101, but alludes to the fact that the user is waiting for a process to be completed (e.g., the message “hand stitching the binding on your ebook” is unrelated to the process causing the unresponsive state). In one embodiment, amusing messages may include song lyrics, such as the song “Still Haven't Found What I'm Looking For” by the band “U2” which makes a light hearted or amusing reference to the fact that the end-user is waiting for a process to be completed.

FIG. 2C depicts an exemplary content data structure capable of storing user-specific content in accordance with embodiments of the present invention. As illustrated by the embodiment depicted in FIG. 2C, content data structure 126 or listing may be capable of storing a plurality of different content (e.g., content 140-1, 141-1, 142-1, etc.) for a plurality of different end-users (e.g., end-users 205, 305, 405, etc.). In one embodiment, content data structure 126 may be capable of storing a plurality of different content for a single user (e.g., user 205, 305, or 405). As such, in one embodiment, content data structure 126 may be capable of storing tables or lists that may be used by content determination module 127 to communicate a set of content to client devices. In one embodiment, data stored within content data structure 126 may be gathered via graphical user interfaces (GUIs) that prompt end-users to provide information applicable to other end-users.

In one embodiment, content communicated by content determination module 127 to end-users may be correlated to the amount of information provided by the end-user. For instance, as more information is provided by the end-user, content determination module 127 may be able to better determine which of the content stored within content data structure 126 may be most desirable to the end-user.

In one embodiment, user-specific content stored within content data structure 126 may be classified in accordance with various different classifications. In one embodiment, content types stored within content data structure 126 may include, but are not limited to, short on-screen messages, advertisements, real-time data, images, etc. In one embodiment, content (e.g., short on-screen messages) may be configured to be of pre-determined length (e.g., pre-determined character length) and/or displayed for a pre-determined period of time (e.g., display for a minimum of 1 second) so as to enable a user to comfortably read the content displayed.

In one embodiment, content may include advertisement messages that are commercial in nature and targeted for specific users or generic for any user. As such, advertisement messages may also be configured to be of pre-determined length and/or displayed for a pre-determined period. In one embodiment, advertisements may include images. Furthermore, in one embodiment, real-time data may include data capable of being pulled from a live feed (e.g., RSS feed) and may include dynamic content such as real-time stock quotes, news feeds, etc. Similarly, real-time data content may be configured to be of pre-determined length and/or displayed for a pre-determined period of time.

Additionally, in one embodiment, user-specific content may be classified by a particular content genre (e.g., “insightful”, “advice/strategy”, “comical”, etc.). Content genres may be used to describe the general tone or nature of the content. Also, content genres may include various gradients or degrees within their respective genre labels, which may be used to further classify a specific content genre (e.g., “mildly insightful”, “light-hearted comedy”, etc.). In one embodiment, genre labels may be combined to form hybrid labels (e.g., “insightful and comedic”).

Furthermore, according to one embodiment, content may be classified by a particular profession applicable to an end-user (e.g., author, financial services expert, comedian, etc.). In one embodiment, a number of different classifications may be used in combination to logically characterize a profession. For instance, those involved in the finance industry may be characterized as being interested in reading content concerning financial strategies and/or receiving real-time stock quotes. As such, embodiments of the present invention may use learning-machine procedures to logically equate certain types of content to a respective profession and automatically communicate content based on the user specifying her profession. For instance, in one embodiment, content determination module 127 may communicate content concerning financial strategies and/or real-time stock quotes in response to the user specifying that her profession is related to the financial services industry.

It should be appreciated that embodiments of the present invention may support configurations in which fewer classifications or more classifications are employed than those depicted in FIG. 2C.

FIG. 2D depicts exemplary display periods associated with a set of user-specific content displayed during an extended wait period in accordance with one embodiment of the present invention. As illustrated in FIG. 2D, an end-user may experience an extended wait period (e.g., wait period 304) of unknown duration while server system 101 performs a particular process or set of processes. In this manner, a client device (e.g., client devices 200, 300, 400, etc.) may be instructed by server system 101 to render an animated object for the duration of extended wait period 304.

As such, simultaneous to the display of the animated object, content determination module 127 may be configured to communicate a set of content that may rendered by the client device during extended wait period 304. For example, sub-periods 1 through 5 may represent consecutive time periods within extended wait period 304 in which an animated object may be rendered by the client device. As such, in one embodiment, several short on-screen messages (e.g., messages 514, 515, 516, 517) may also be communicated from server system 101 to the client device in which they may be displayed to an end-user during each sub-period within extended wait period 304. In this manner, in one embodiment, content determination module 127 may be configured to display multiple new messages during sub-periods 1 through 5. In one embodiment, the set of content may be pre-configured to be of pre-determined length (e.g., pre-determined character length) and/or displayed for a pre-determined period of time (e.g., display for a minimum of 1 second) so as to enable a user to comfortably read the set of content displayed during extended wait period 304.

For instance, as illustrated by the embodiment depicted in FIG. 2D, content determination module 127 may be configured to display message 514 on the end-user's device between sub-periods 1 and 2. Upon completion of sub-period 1 and at the beginning of sub-period 2, content determination module 127 may then communicate a new message (e.g., message 515) that may be displayed by the client device. Upon completion of sub-period 2 and at the beginning of sub-period 3, content determination module 127 may then communicate another new message (e.g., message 516) that may be displayed by the client device. Furthermore, upon completion of sub-period 3 and at the beginning of sub-period 4, content determination module 127 may communicate yet another new message (e.g., message 517) that may be displayed by the client device. In one embodiment, content determination module 127 may be capable of tracking the amount of time each client device has spent waiting and may correspondingly communicate a new message based on the wait time.

In this manner, messages 514, 515, 516, and 517 may each be separately displayed during separate periods within extended wait period 304. As such, in one embodiment, content data structure 126 may be capable of storing additional tables or lists (e.g., ranked lists) that may be used by content determination module 127 to communicate a set of content from server system 101 to client devices.

FIG. 2E depicts an exemplary set of user-specific content displayed during an extended wait period in accordance with one embodiment of the present invention. As described herein, messages 514, 515, 516, and 517 may include content that may be relevant to the user's profession (e.g., writer) and also alludes to the fact that the end-user is currently waiting for server system 101 to return to an active state. In this manner, messages 514, 515, 516, and 517 may provide amusement to the end-user as she waits for server system 101 to complete any processes causing the delay.

As illustrated in FIG. 2E, in one embodiment, messages 514, 515, 516, and 517 may contain separate content that may be unrelated to each other. According to one embodiment, messages 514, 515, 516, and 517 may be related in content (e.g., content in message 515 may refer to content within message 514, etc.).

According to one embodiment, messages 514, 515, 516, and 517 may include dynamic content that relates to duration of each sub period (e.g., sub periods 1 through 4) within the current wait period (e.g., extended wait period 304). For instance, in one embodiment, content determination module 127 may be configured to communicate an initial message (e.g., message 514) that may contain content that sarcastically refers to the fact that the end-user (e.g. user 205) is currently waiting for a process on server system 101 to complete.

Upon completion of sub-period 1 and at the beginning of sub-period 2, content determination module 127 may be configured to communicate a second message (e.g., message 515) that sarcastically refers to the fact that the end-user is still waiting to for the process to complete. Similarly, completion of sub-period 3 and at the beginning of sub-period 4, content determination module 127 may display yet another new message (e.g., message 516) that again sarcastically refers to the fact that the end-user (e.g. user 205) is still waiting to for the process to complete. In this manner, messages 514, 515, and 516 may include content that may provide amusement to the end-user (e.g. user 205) while she is currently waiting for server system 101 to return to a previous active state.

Furthermore, according to one embodiment, the content included within messages 514, 515, 516 and 517 may increase or decrease with respect to a particular characteristic. For instance, in one embodiment, as more time elapses, messages 514, 515, 516 and 517 may increase with respect to the level of humor (e.g., content within messages 514, 515, 516, and 517 becoming “funnier” or “edgier” as time elapses within extended wait period 304). As such, in one embodiment, content data structure 126 may be capable of storing additional tables or lists (e.g., ranked lists) that may be used by content determination module 127 to communicate a set of content to client devices that increase with respect to a particular characteristic.

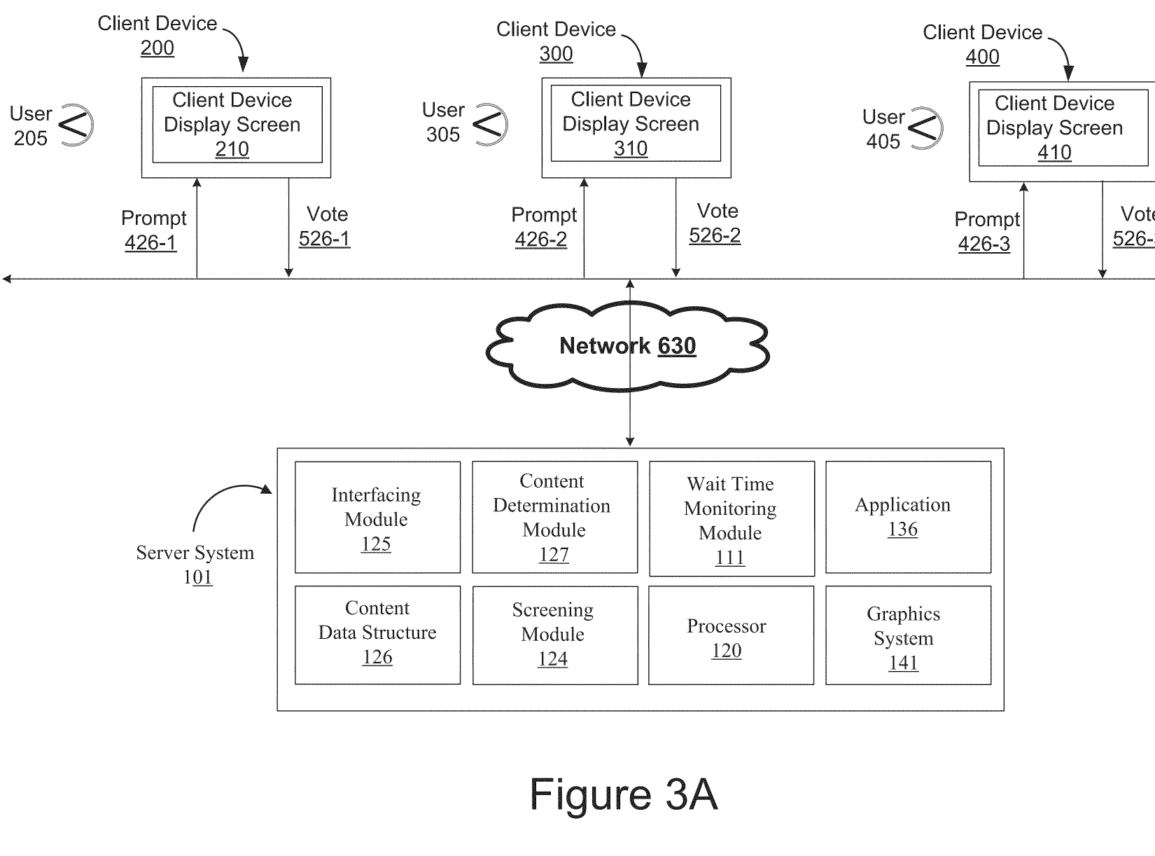

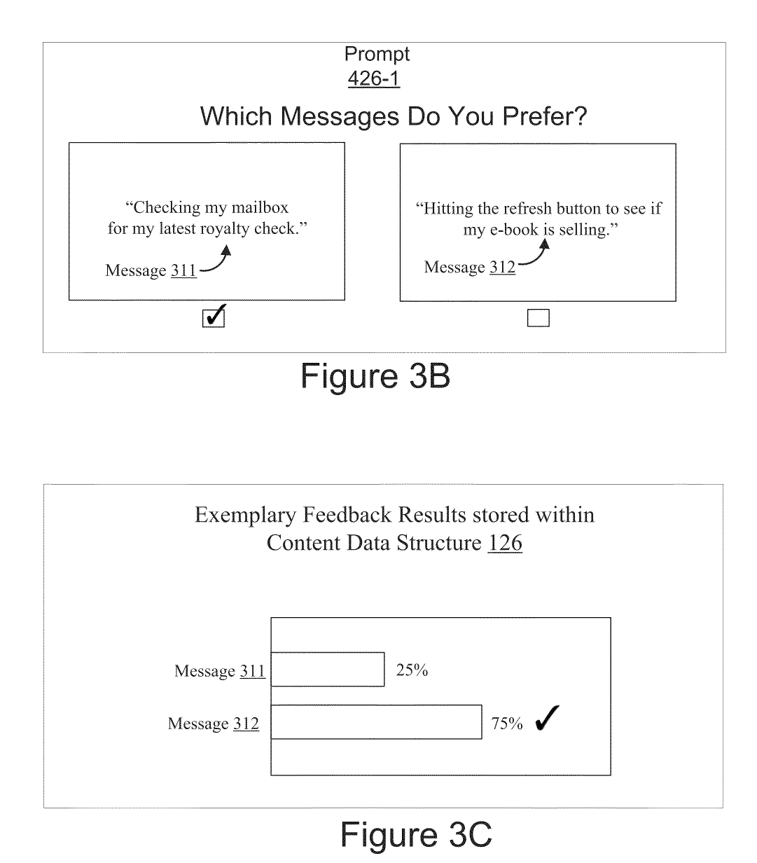

FIG. 3A depicts an exemplary method of selecting content for display to end-users in accordance with embodiments of the present invention. As described herein, in one embodiment, content assigned to end-users may be determined by content determination module 127. In this manner, content determination module 127 may communicate content applicable to end-users based on data gathered and stored within the data structure.

Additionally, with reference to FIG. 3A, according to one embodiment, content determination module 127 may be configured to analyze feedback received from end-users (e.g., users 205, 305, 405, etc.) concerning prospective content that may be displayed to a plurality of client devices. In this manner, prospective content selected by the end-users as the most amusing or most entertaining may be stored within a data structure resident on server system 101 (e.g., content data structure 126) and then communicated to end-users for display during future unresponsive states in accordance with embodiments of the present invention.

According to one embodiment, content determination module 127 may be configured to use crowdsourcing procedures to gather content directly from end-users. For instance, with reference to FIG. 3A, content determination module 127 may be capable of interacting with a plurality of end-users (e.g., users 205, 305, 405, etc.) over a communication network (e.g., network 630) using well-known crowdsourcing algorithms. In one embodiment, content determination module 127 may engage users (via interfacing module 125) to participate in surveys to determine which short messages and/or images the end-users believe is the most amusing. In this manner, the winning selection determined by end-users as the most amusing or most entertaining may be considered the “winner” and communicated to a plurality of end-users for display during future unresponsive states associated with server system 101.

In one embodiment, end-user content submissions may be encouraged through incentives such as providing name and/or brand recognition. For instance, in one embodiment, content determination module 127 may append the winner's name to her winning submission, thus providing her with increased visibility among the plurality of end-users (e.g., users who share the same profession as the winner). In one embodiment, end-users may participate in the selection process through texting technology (e.g., MMS technology) in which user feedback is collected in response to text and/or picture messages sent to the end-user.

Furthermore, to maintain the integrity of the submissions received from end-users, embodiments of the present invention may screen content submissions provided by end-users (e.g., users 205, 305, 405, etc.) using screening module 124. Screening module 124 may perform various screenings or filters on the submissions received from end-users. For instance, in one embodiment, profanity screenings on the content submitted, end-user verification (e.g., verifying the submission is actually from the user stated), end-user eligibility (e.g., minor/adult verification, etc.), or the like may be employed by screening module 124 before considering the end-user's submission as prospective content.

As illustrated in the embodiment depicted in FIG. 3A, content determination module 127 may gather user feedback concerning submitted content through a voting process (e.g., votes 526-1, 526-2, 526-3, etc.) in which end-users may express their preference towards a particular content for display during future unresponsive states associated with server system 101. For instance, in one embodiment, users may be presented (e.g., prompts 426-1, 426-2, 426-3, etc.) with a set of screened prospective content and asked to select which one the user considers to be the most amusing or entertaining.

FIG. 3B depicts an exemplary display prompt that may be used to gather user feedback concerning prospective content in accordance with embodiments of the present invention. As illustrated in FIG. 3B, in one embodiment, the end-user may express feedback through placement of a mark (e.g., checkmark placed within a radio field) next to the content (e.g., messages 311, 312) that the end-user likes the most. According to one embodiment, end-users using touchscreen display screens may touch the content (e.g., message) displayed to express a preference. In another embodiment, the end-user may provide feedback by ranking the content (e.g., messages) displayed. For instance, messages rated as the most amusing or entertaining may receive a higher rank than those deemed less amusing or entertaining. In one embodiment, images considered the most amusing or entertaining may receive a higher rank than those deemed less amusing or entertaining.

It may be appreciated that embodiments of the present invention are not limited to the number of messages displayed within prompt 426-1 of FIG. 3B and may contain more selections.

With further reference to FIG. 3A, server system 101 may to store feedback provided by users within content data structure 126. According to one embodiment, content determination module 127 may use voting data stored in content data structure 126 to determine winning selections (e.g., message 312 in FIG. 3C). As such, message 312 may be displayed by server system 101 to client devices during future unresponsive states.

FIG. 4A shows a flowchart of an exemplary computer controlled process for displaying user-specific content on-screen contemporaneously with an animated widget in accordance with one embodiment of the present invention.

At step 605, the wait time monitoring module sends signals to the content determination module responsive to a detection of the computing device being placed in an unresponsive state and/or instructions sent by the computing device to a graphics system resident on the computing device to render animated objects to a graphical user interface displayed to an end-user responsive to the computing device being placed within an unresponsive state.

At step 606, the content determination module receives signals sent from the wait time monitoring module at step 605 and selects content (e.g., profession-specific content) to be rendered contemporaneously with the animated object displayed on the graphical user interface. Selections made by the content determination module concerning the content to be rendered are based on preferences previously defined by the end-user and unrelated to a main content (e.g., currently executed application) and/or an action currently being performed by the computing device during the unresponsive state.

At step 607, graphics system renders the user-specific content selected during step 606 contemporaneously with the animated object displayed on the graphical user interface.

At step 608, a determination is made as to whether the content determination module received signals from the wait time monitoring module indicating that the computing device has returned to a previous active state. If signals were received from the wait time monitoring module indicating that the computing device has returned to a previous active state, then the content determination module sends instructions to the graphics system to terminate the rendering of the user-specific content, as detailed in step 609. If signals were not received from the wait time monitoring module that the computing device has returned to a previous active state, then the graphics system continues to render the user-specific content selected during step 606 contemporaneously with the animated object displayed on the graphical user interface, as detailed in step 607.

At step 609, the content determination module received signals from the wait time monitoring module indicating that the computing device has returned to a previous active state and, therefore, the content determination module sends instructions to the graphics system to terminate the rendering of the user-specific content.

At step 610, the graphics system terminates the rendering of the user-specific content and the computing device resumes standard operations performed during a previous active state.

FIG. 4B shows a flowchart of an exemplary computer controlled process for selecting specific content for end-users using a voting process to determine specific content for end-users in accordance with one embodiment of the present invention.

At step 705, the computing device receives a plurality of user-submitted content (e.g., amusing messages) associated with a specific profession (e.g., writer) from a plurality of users, which is collected and stored within a data structure resident on the computing device.

At step 706, the screening module performs screening operations on the content gathered during step 705 to filter out invalid submissions (e.g., profane submissions and/or invalid participants, etc.) and maintain the integrity of the content collected by the computing device.

At step 707, the content determination module broadcasts a select subset of content screened during step 706 to a plurality of users over a communications network using crowdsourcing procedures to gather feedback concerning the content presented to the users.

At step 708, using a client device, each user selects the content that the user determines is the most amusing from the set of content presented to each user during step 707.

At step 709, each user's selection is recorded and communicated back to the computing device over the communications network and stored within the data structure.

At step 710, the user selections stored within the data structure are accessed by the content determination module, which then determines which user-submitted content received the most number of votes.

At step 711, the user-submitted content receiving the most number of votes, as determined by the content determination module during step 710, is selected to be broadcasted in the future to a plurality of users interested in receiving content (e.g., amusing messages) associated with the specific profession (e.g., writer). The user submitting the content receiving the most number of votes may have their name broadcasted along with the winning submission during a future broadcast of the winning submission.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of rendering content on a display of a computing device, said method comprising:
rendering an animated object on a graphical user interface responsive to a detection of an unresponsive state associated with said computing device;
receiving a selection of an amusing content to be displayed contemporaneously with said animated object during said unresponsive state wherein said amusing content is specific to a user;
rendering said amusing content contemporaneously with said animated object on said graphical user interface; and
detecting an active state associated with said computing device, wherein rendering of said amusing content is terminated upon said detection of said active state.

2. The method as described in claim 1, further comprising supplying user-specific data associated with said user, wherein said amusing content is unrelated to an application or system process causing said unresponsive state.

3. The method as described in claim 2, wherein user-specific data is related to a profession associated with said user.

4. The method as described in claim 1, wherein said amusing content is a short message displayed adjacent to said animated object.

5. The method as described in claim 1, further comprising selecting said amusing content and wherein said selecting further comprises receiving a plurality of prospective content from a plurality of users and selecting said amusing content from said plurality of prospective content based on votes received from a plurality of voters.

6. The method as described in claim 5, wherein said receiving further comprises screening said plurality of prospective content for profanity.

7. The method as described in claim 1, wherein said amusing content comprises a plurality of short messages and wherein said rendering comprises respectively rendering said plurality of short messages during said unresponsive state.

8. A system for rendering content on a computing device during an unresponsive state, said system comprising:
a rendering module operable to render an animated object to a graphical user interface displayed by said computing device responsive to a detection of an unresponsive state associated with said computing device, wherein said rendering module is also operable to render an amusing content contemporaneously with said animated object on said graphical user interface;
a selection module operable to receive a selected amusing content to be displayed contemporaneously with said animated object wherein said amusing content is separate from an application or a system process executed by said computing device during said unresponsive state; and
a detection module operable to detect an active state associated with said computing device, wherein said rendering module is operable to terminate rendering of said amusing content is upon said detection of said active state by said detection module.

9. The system as described in claim 8, wherein said selection module is further operable to gather user-specific data associated with a user, wherein said amusing content comprises user-specific data provided by said user.

10. The system as described in claim 9, wherein said user-specific data is related to a profession associated with said user.

11. The system as described in claim 8, wherein said amusing content is a short message displayed adjacent to said animated object.

12. The system as described in claim 8, wherein said selection module is further operable to receive a plurality of prospective content from a plurality of users and select said amusing content from said plurality of prospective content based on votes received from a plurality of voters.

13. The system as described in claim 12, further comprising a screening module operable to screen said plurality of prospective content for profanity.

14. The system as described in claim 8, wherein said amusing content comprises a plurality of short messages for respective display during said unresponsive state.

15. A method of rendering content on a client device during an unresponsive state, said method comprising:
rendering an animated object to a graphical user interface associated with a client device responsive to a detection of an unresponsive state associated with said host device;
selecting an amusing content to be displayed contemporaneously with said animated object on said client device wherein said amusing content is user-specific; and
rendering said amusing content contemporaneously with said animated object on said graphical user interface; and
detecting an active state associated with said host device, wherein rendering of said amusing content is terminated upon said detection of said active state.

16. The method as described in claim 15, wherein said selecting further comprises gathering user-specific data associated with a user and wherein said amusing content is separate from an application or a system process executed by said host device during said unresponsive state.

17. The method as described in claim 16, wherein user-specific data is related to a profession associated with said user.

18. The method as described in claim 15, wherein said amusing content is a short message displayed adjacent to said animated object.

19. The method as described in claim 15, wherein said selecting further comprises receiving a plurality of prospective content from a plurality of users and selecting said amusing content from said plurality of prospective content based on votes received from a plurality of voters.

20. The method as described in claim 15, wherein said amusing content is an advertisement.

21. The method as described in claim 15, wherein said amusing content comprises a plurality of short messages and wherein said rendering comprises respectively rendering said plurality of short messages during said unresponsive state.
